(19) United States
(12) Patent Application Publication
(10) Pub. No.: US 2008/0097772 A1
(43) Pub. Date: Apr. 24, 2008

(54) Automatic disposition of referrals in an online marketplace

(75) Inventors: Nicholas Brown, West Jordan, UT (US); Shawn D. Lindberg, Salt Lake City, UT (US); Joey Mounarath, Irving, TX (US); Ryan W. Schofield, Salt Lake City, UT (US); Josh Sumner, Draper, UT (US); Jon Watkins, Riverton, UT (US)

Correspondence Address: SCHWEGMAN, LUNDBERG & WOESSNER/EBAY, P.O. BOX 2938, MINNEAPOLIS, MN, 55402, US

(73) Assignee: eBay Inc.

(21) Appl. No.: 11/584,839

(22) Filed: Oct. 23, 2006

(51) Int. Cl. G06Q 30/00

(52) U.S. Cl. 705/1; 705/500; 705/26

(57) ABSTRACT

A computer-implemented method and system is operable to: receive a referral, the referral including referral information identifying a referred party, obtain referred party information related to the referred party, and use the referral information and the referred party information to automatically produce a disposition for the referral.

### BACKGROUND

1. Technical Field

This disclosure relates to methods and systems supporting online marketplaces. More particularly, the present disclosure relates to the automatic disposition of referrals in an online marketplace.

2. Related Art

The Internet has created a vast global online marketplace where buyers and sellers can connect for the sale of goods and services. Unfortunately however, the online marketplace also attracts fraud, misrepresentation, harassment, and other forms of behavior that undermine the efficiency and popularity of the online marketplace. In many cases, consumer or seller complaints are used to inform a marketplace host site that undesirable behavior is occurring in the online marketplace. In other cases, the host site itself or other third parties can identify and notify of a potential instance of undesirable behavior. These complaints or notifications, collectively called referrals, can trigger an investigation by the host site or others into the basis and legitimacy of the referral. These investigations can gather evidence, communicate with involved parties, and ultimately conclude whether some action may be necessary to eliminate the undesirable behavior.

Because of the complexity of the process of receiving and disposing of referrals in an online marketplace, conventional systems have employed large numbers of customer support representatives (CSR) to manually receive referrals, gather and analyze related evidence, and dispose of referrals by initiating some action, if necessary. However, a large online marketplace requires a large number of CSR's and a significant recurring expense to manage the disposition of referrals.

Thus, a system and method for automatic disposition of referrals in an online marketplace are needed.

### BRIEF DESCRIPTION OF THE DRAWINGS

Embodiments illustrated by way of example and not limitation in the figures of the accompanying drawings, in which:

FIG. 1 is a block diagram of a network system on which an embodiment may operate.

FIGS. 2 and 3 are block diagrams of a computer system on which an embodiment may operate.

FIG. 4 illustrates an example of an online marketplace.

FIG. 5 illustrates examples of several sources for referrals in an embodiment.

FIG. 6 illustrates a system diagram of one embodiment.

FIGS. 7-8 are flow diagrams illustrating the processing flow in various embodiments.

FIG. 9 illustrates a mapping between a referral source and a matching policy in an example embodiment.

FIG. 10 illustrates a mapping between a policy and an assigned consequence package identifier (ID) in an example embodiment.

FIG. 11 illustrates examples of consequence packages as identified by a consequence package ID.

FIG. 12 illustrates examples of computer-implemented rules that can be used to automatically assign a consequence package ID for a corresponding policy and thus a corresponding referral.

FIG. 13 illustrates an example of another embodiment.

### DETAILED DESCRIPTION

A computer-implemented system and method for automatic disposition of referrals in an online marketplace are disclosed. In the following description, numerous specific details are set forth. However, it is understood that embodiments may be practiced without these specific details. In other instances, well-known processes, structures and techniques have not been shown in detail in order not to obscure the clarity of this description.

As described further below, according to various example embodiments of the disclosed subject matter described and claimed herein, there is provided a system and method for automatic disposition of referrals in an online marketplace. The system includes a referral receiver operable to receive a referral, the referral including referral information identifying a referred party, the referral receiver being further operable to obtain referred party information related to the referred party. The system further includes a referral disposition engine being operable to use the referral information and the referred party information to automatically produce a disposition for the referral. Various embodiments are described below in connection with the figures provided herein.

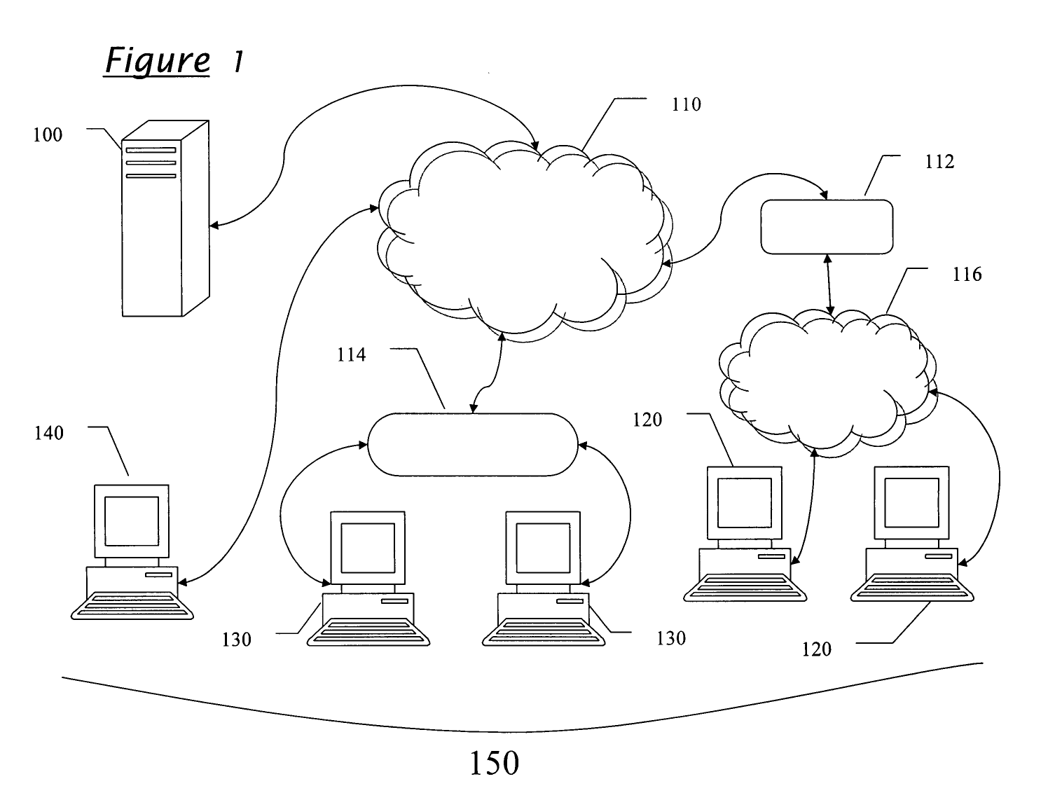

Referring to FIG. 1, a diagram illustrates a network environment in which various example embodiments may operate. In this conventional network architecture, a server computer system 100 is coupled to a wide-area network 110. Wide-area network 110 includes the Internet, or other proprietary networks, which are well known to those of ordinary skill in the art. Wide-area network 110 may include conventional network backbones, long-haul telephone lines, Internet service providers, various levels of network routers, and other conventional means for routing data between computers. Using conventional network protocols, server 100 may communicate through wide-area network 110 to a plurality of client computer systems 120, 130, 140 connected through wide-area network 110 in various ways. For example, client 140 is connected directly to wide-area network 110 through direct or dial-up telephone or other network transmission line. Alternatively, clients 130 may be connected through wide-area network 110 using a modem pool 114. A conventional modem pool 114 allows a plurality of client systems to connect with a smaller set of modems in modem pool 114 for connection through wide-area network 110. In another alternative network topology, wide-area network 110 is connected to a gateway computer 112. Gateway computer 112 is used to route data to clients 120 through a local area network (LAN) 116. In this manner, clients 120 can communicate with each other through local area network 116 or with server 100 through gateway 112 and wide-area network 110.

Using one of a variety of network connection means, server computer 100 can communicate with client computers 150 using conventional means. In a particular implementation of this network configuration, a server computer 100 may operate as a web server if the Internet's World-Wide Web (WWW) is used for wide area network 110. Using the HTTP protocol and the HTML coding language across wide-area network 110, web server 100 may communicate across the World-Wide Web with clients 150. In this configuration, clients 150 use a client application program known as a web browser such as the Internet Explorer™ published by Microsoft Corporation of Redmond, Wash., the user interface of America On-Line™, or the web browser or HTML renderer of any other supplier. Using such conventional browsers and the World-Wide Web, clients 150 may access image, graphical, and textual data provided by web server 100 or they may run Web application software. Conventional means exist by which clients 150 may supply information to web server 100 through the World Wide Web 110 and the web server 100 may return processed data to clients 150.

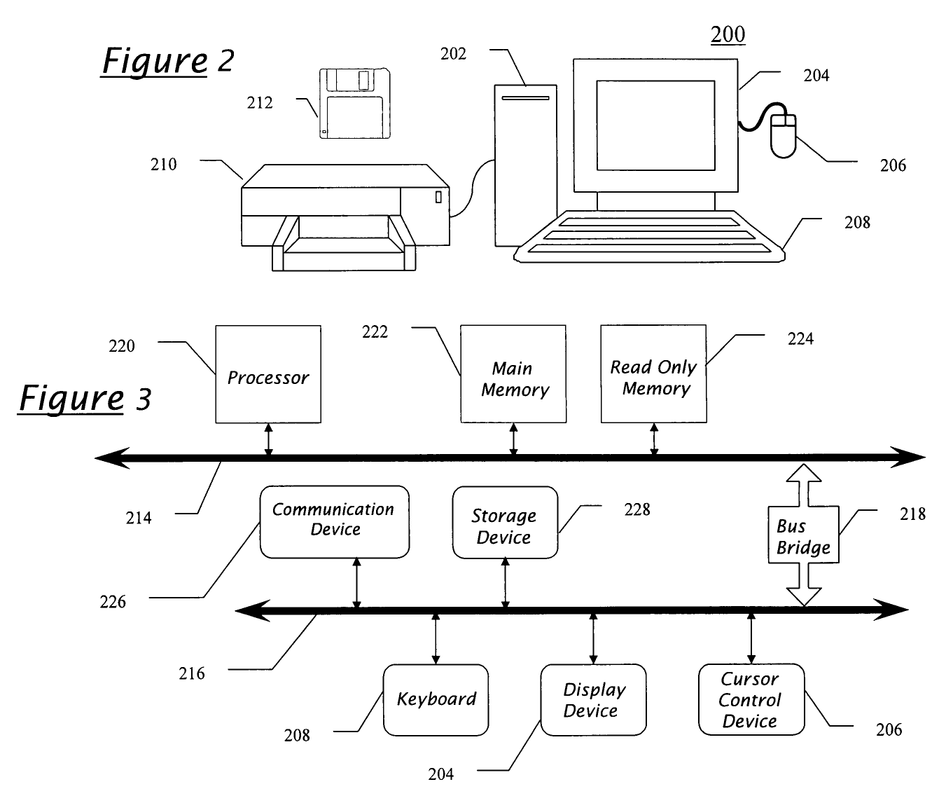

Having briefly described one embodiment of the network environment in which an example embodiment may operate, FIGS. 2 and 3 show an example of a computer system 200 illustrating an exemplary client 150 or server 100 computer system in which the features of an example embodiment may be implemented. Computer system 200 is comprised of a bus or other communications means 214 and 216 for communicating information, and a processing means such as processor 220 coupled with bus 214 for processing information. Computer system 200 further comprises a random access memory (RAM) or other dynamic storage device 222 (commonly referred to as main memory), coupled to bus 214 for storing information and instructions to be executed by processor 220. Main memory 222 also may be used for storing temporary variables or other intermediate information during execution of instructions by processor 220. Computer system 200 also comprises a read only memory (ROM) and /or other static storage device 224 coupled to bus 214 for storing static information and instructions for processor 220.

An optional data storage device 228 such as a magnetic disk or optical disk and its corresponding drive may also be coupled to computer system 200 for storing information and instructions. Computer system 200 can also be coupled via bus 216 to a display device 204, such as a cathode ray tube (CRT) or a liquid crystal display (LCD), for displaying information to a computer user. For example, image, textual, video, or graphical depictions of information may be presented to the user on display device 204. Typically, an alphanumeric input device 208, including alphanumeric and other keys is coupled to bus 216 for communicating information and/or command selections to processor 220. Another type of user input device is cursor control device 206, such as a conventional mouse, trackball, or other type of cursor direction keys for communicating direction information and command selection to processor 220 and for controlling cursor movement on display 204.

Alternatively, the client 150 can be implemented as a network computer or thin client device. Client 150 may also be a laptop or palm-top computing device, such as the Palm Pilot™. Client 150 could also be implemented in a robust cellular telephone, where such devices are currently being used with Internet micro-browsers. Such a network computer or thin client device does not necessarily include all of the devices and features of the above-described exemplary computer system; however, the functionality of an example embodiment or a subset thereof may nevertheless be implemented with such devices.

A communication device 226 is also coupled to bus 216 for accessing remote computers or servers, such as web server 100, or other servers via the Internet, for example. The communication device 226 may include a modem, a network interface card, or other well-known interface devices, such as those used for interfacing with Ethernet, Token-ring, or other types of networks. In any event, in this manner, the computer system 200 may be coupled to a number of servers 100 via a conventional network infrastructure such as the infrastructure illustrated in FIG. 1 and described above.

The system of an example embodiment includes software, information processing hardware, and various processing steps, which will be described below. The features and process steps of example embodiments may be embodied in articles of manufacture as machine or computer executable instructions. The instructions can be used to cause a general purpose or special purpose processor, which is programmed with the instructions to perform the steps of an example embodiment. Alternatively, the features or steps may be performed by specific hardware components that contain hard-wired logic for performing the steps, or by any combination of programmed computer components and custom hardware components. While embodiments are described with reference to the Internet, the method and apparatus described herein is equally applicable to other network infrastructures or other data communications systems.

Various embodiments are described herein. In particular, the use of embodiments with various types and formats of user interface presentations and/or application programming interfaces may be described. It will be apparent to those of ordinary skill in the art that alternative embodiments of the implementations described herein can be employed and still fall within the scope of the claimed invention. In the detail herein, various embodiments are described as implemented in computer-implemented processing logic denoted sometimes herein as the “Software”. As described above, however, the claimed invention is not limited to a purely software implementation.

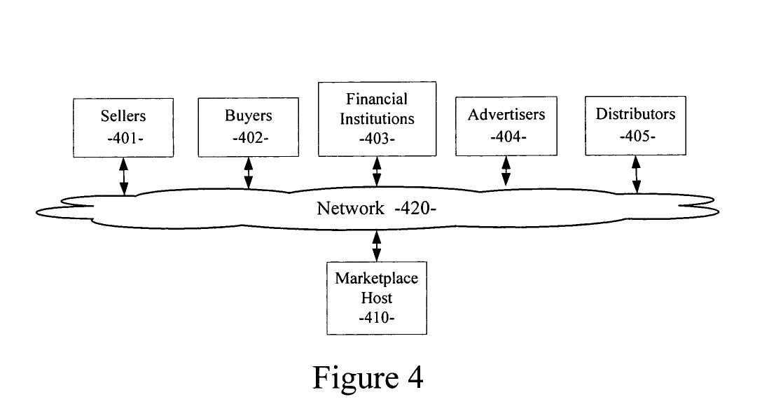

FIG. 4 illustrates an example of an online marketplace. In the example online marketplace, a plurality of parties 401-405 is interconnected through a marketplace host 410 via a network 420. In such a configuration, the marketplace host 410 can facilitate the listing of goods or services offered for sale by sellers 401. The marketplace host 410 can also facilitate the purchase of listed goods or services by buyers 402. Financial institutions 403, advertisers 404, and distributors 405 can also facilitate the sale/purchase transaction between buyer 402 and seller 401. It will be apparent to those of ordinary skill in the art that many other configurations can be employed to implement an online marketplace.

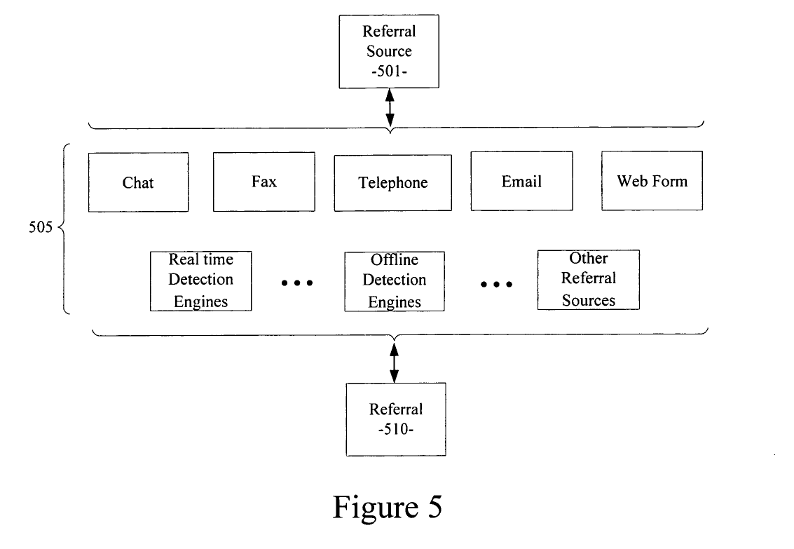

FIG. 5 illustrates examples of several sources for referrals. Referrals can be notifications from a third party to the marketplace host to inform the marketplace host of a problem or concern regarding the operation of the online marketplace. In one example, a referral source (e.g. a participant in the online marketplace) can inform the marketplace host of a potential fraudulent transaction or listing, an identity theft or fraudulent registration, a compromised account, an incidence of spam, or other condition that may require action by the online marketplace host. The referral source can use any of a variety of communication means to submit the referral to the marketplace host. As shown in FIG. 5, a referral 510 can be submitted by the referral source 501 using any of a variety of communication means 505, such as online chat or instant message, facsimile, telephone, email, web form, or other means to communicate a referral to the online marketplace. The referral source can include human beings (e.g. a participants in the online marketplace) and other real time or offline detection engines that are programmed to submit referrals based on rules or data processing events. In most cases, the referral 510 will include the identity of the referral source, a description of the problem or concern being reported, and an identity of the referred party, if known. The referred party is the potential source of the problem or concern being reported by the referral source.

The referral can be a structured data object, such as a web form or an email form with defined data fields and enumerated value selections. The referral source can select from the various value options provided for each field. In other embodiments, a less structured referral can be provided as a group of free text fields that can be scanned for keywords and converted to a structured data object using well known techniques. In these various embodiments, the identity of the referral source, if provided, can be extracted from the referral. Similarly, the identity of the referred party, if provided, can also be extracted from the referral.

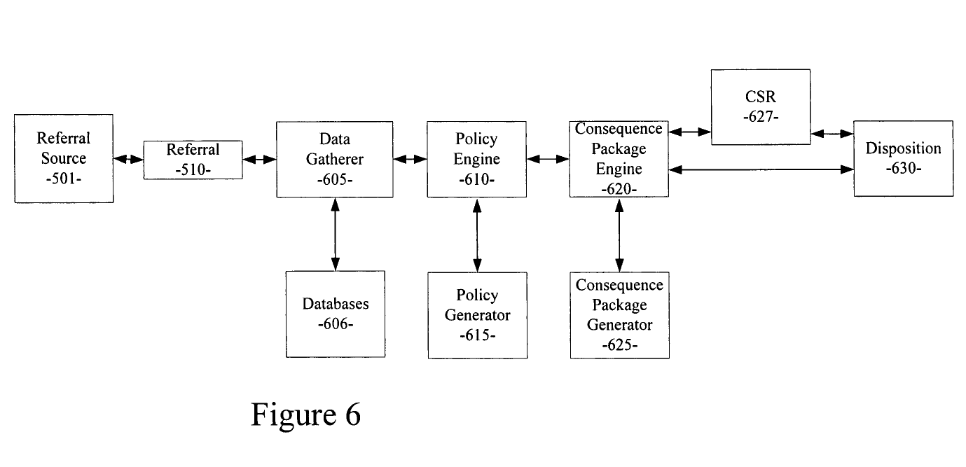

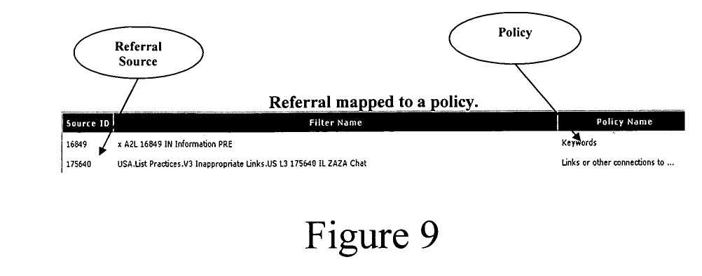

Referring now to FIG. 6, a system diagram of one embodiment is illustrated. In this example, a referral source 501 provides a referral 510 to a data gatherer component 605. The data gatherer component 605 uses information provided in the referral 510 to obtain other related information from databases 606. The other related information can include historical, behavioral, transactional, demographic, or other types of information related to the referral source and/or the referred party as identified in the referral 510. The other related information obtained by data gatherer component 605 can also include details of the referred matter as provided in the referral 510. The information obtained and aggregated by data gatherer component 605 is used by policy engine 610 to automatically identify and select a policy that most closely matches the referral 510 based on the information automatically obtained by data gatherer component 605. For example, FIG. 9 illustrates a mapping between a referral source and a matching policy in an example embodiment. In other embodiments, other related information associated with a referral 510 can be used to provide other automatic mappings to matching policies.

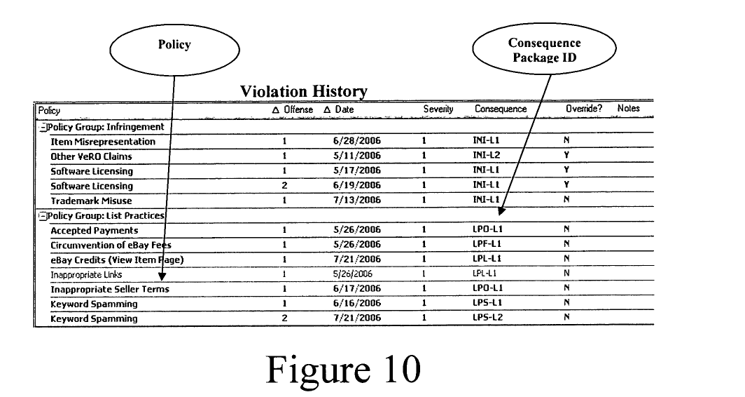

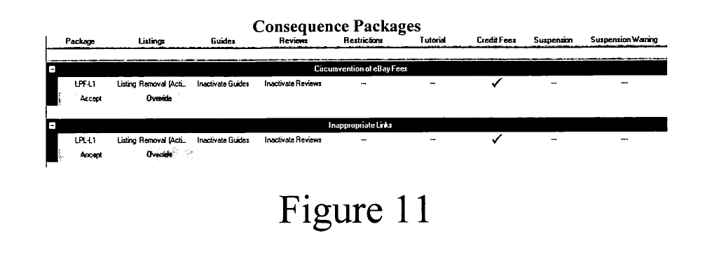

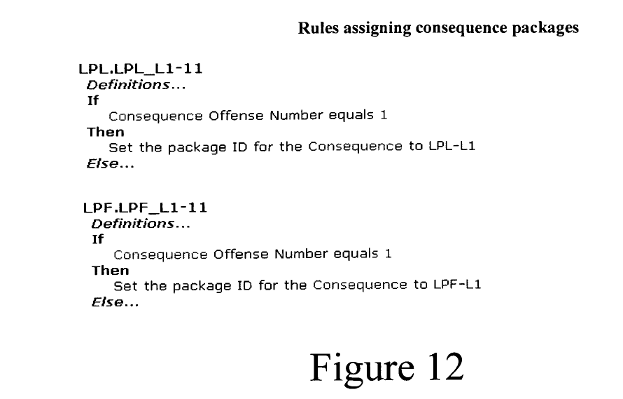

Once a policy is matched to the referral 510 by the policy engine 610, the selected policy is provided to consequence package engine 620. The consequence package engine 620 assigns a consequence package to the referral 510 based on the selected policy. For example, FIG. 10 illustrates a mapping between a policy and an assigned consequence package identifier (ID) in an example embodiment. The consequence package ID can be used by the consequence package engine 620 to obtain information and instructions associated with a corresponding consequence package. In other embodiments, other related information associated with a referral 510 can be used to provide other automatic mappings to assigned consequence package ID's and a corresponding consequence package. FIG. 11 illustrates examples of consequence packages as identified by a consequence package ID. The consequence package can define a set of information, conditions, restrictions, actions, and the like that may be automatically processed when the consequence package is activated as a result of being assigned by the consequence package engine 620. FIG. 12 illustrates examples of computer-implemented rules that can be used to automatically assign a consequence package ID for a corresponding policy and thus a corresponding referral 510.

Once the consequence package engine 620 assigns a consequence package to the referral 510, the actions defined by the assigned consequence package can be automatically performed leading to disposition 630 of the referral 510. Alternatively, the actions defined by the assigned consequence package may require that at least one step be performed manually by a customer service representative (CSR) 627. In this case, the consequence package and the referral can be provided to CSR 627. The CSR 627 can perform any required manual steps and then other steps defined by the assigned consequence package can be automatically performed leading to disposition 630.

As shown in FIG. 6, various embodiments may also include a policy generator 615 and a consequence package generator 625. Policy generator 615 is typically used by a marketplace host system administrator to create or modify the system policies that are used to process incoming referrals. In one embodiment, policies can be implemented as a set or rules or processing steps that can be automatically executed when triggered by a matching referral. Each created policy can include a specification of the events, data values, parameters, system status, time of day or date, and the like necessary to trigger the execution of the policy. Each policy can also include additional configurable policy triggering parameters that can be used to selectively vary a threshold at which the policy will be triggered. In this manner, one or more configurable policy triggering parameters can be selectively modified at run time to change the point at which the policy is triggered. For example, if a flurry of referrals flood the marketplace host during a short time span, the configurable policy triggering parameters can be modified to raise the policy triggering threshold and thereby filter out the further processing of referrals for a given period. In another example, the configurable policy triggering parameters can be modified automatically at particular times of day or days of the week given the behavior of a particular online marketplace. The configurable policy triggering parameters thereby provide a, “a business dial” that can dynamically modify the threshold for when to take action in an automated manner. This serves as a safety valve for the online marketplace for dealing with peaks in fraudulent activity. Essentially, the online marketplace host remains operable even as fraudulent activity peaks with a tradeoff on more false positives.

Policy generator 615 can be used to create a variety of policies to automatically handle a variety of referrals. Each policy so generated can be identified with a unique policy name or number and stored for ready access by the policy engine 610. A particular policy can be created to parse the information obtained and aggregated by data gatherer component 605. For example, the policy generator 615 can analyze the attributes and behaviors of the party(s) identified in the referral to determine if there has been a demonstrable change in status or behavior that may indicate a potential problematic or fraudulent use of an online marketplace account. The generated policy can perform this automated analysis, generate specific dataset and reports, and automatically recommend actions to be performed in response to the information in the referral and the other information aggregated by data gatherer component 605. The actions to be taken as automatically recommended by the policy are defined as consequence packages generated by the consequence package generator 625.

Consequence package generator 625 is typically used by a marketplace host system administrator to create or modify the system consequence packages that are used to respond to processed referrals. In one embodiment, consequence packages can be implemented as a set or rules or processing steps that can be automatically executed when triggered by an associated policy. Each created consequence package can include a specification of the events, data values, parameters, system status, time of day or date, and the like necessary to trigger the execution of the consequence package. Each consequence package can also include additional configurable consequence package triggering parameters that can be used to selectively vary a threshold at which the consequence package will be triggered. In this manner, one or more configurable consequence package triggering parameters can be selectively modified at run time to change the point at which the consequence package is triggered. Each consequence package so generated can be identified with a unique consequence package name or number and stored for ready access by the consequence package engine 620.

Consequence package generator 625 can be used to create a variety of consequence package to automatically handle a variety of referrals. The consequence package essentially defines the set of actions to perform in support of the policy triggered for a particular incoming referral. For example, a particular consequence package could include a rule as simple as automatically generating and sending an email to a pre-defined recipient when an associated policy is triggered. As such, a particular policy can include an identity of one or more consequence packages to execute upon the triggering of the related policy. As another example, a particular consequence package could include a rule that would refer the matter to a human CSR 627 for manual processing of the referral. Because each consequence package includes configurable consequence package triggering parameters, the one or more configurable consequence package triggering parameters can be selectively modified at run time to change the point at which the consequence package is triggered. In this manner, for example, the online marketplace can be quickly reconfigured at runtime to refer most or all matters to a human CSR 627 for manual processing of the referral if conditions in the online marketplace warrant such action. This way, the processing of referrals in the online marketplace can be quickly and configurably switched between an automatic or manual referral processing mode.

Because the process in various embodiments of selecting a policy associated with an input referral and then selecting a consequence package associated with the selected policy can be completely automated, the related sending of notifications related to the disposition of the referral can also be automated. For example, the referral source as identified in the referral and/or the referred party, if identified in the referral, can be automatically notified of the submittal, processing, and disposition of a related referral. This automatic notification (e.g. email, fax, instant message, automated voicemail, page, etc.) happens automatically and does not need to involve any Customer Support time or manual processing. For example, the notification to the User/Member can specify the policy that the party may have violated

As described above, various embodiments can automatically process referrals by selecting one or more policies and one or more consequence packages for disposing of a particular referral. In a similar fashion, multiple referrals can be aggregated into a single mass referral unit and disposed together as a mass referral unit. Further, duplicate or substantially similar referrals can be reduced to one or more fewer referrals to reduce the processing time in handling multiple duplicate referrals. In one example, multiple referrals may have been originated by the same referral source or may have originated from the same set of circumstances. In this case, the multiple similar referrals are collected over a given pre-determined time period as specified in a pre-defined policy. Upon the expiration of a pre-configured time period or referral quantity, the collected multiple referrals are aggregated into a single mass referral unit and a pre-defined consequence package is selected to process a set of actions associated with the mass referral unit. As described above, the set of actions defined by the consequence package may be one or more actions that would be available for disposing of a single referral. For example, a single email message can be sent to a pre-defined recipient as an action associated with the disposition of the mass referral unit. In another example, the mass referral unit can be forwarded to a human CSR 627 for manual processing as a mass referral unit. In this manner, the CSR 627 can manually dispose of multiple referrals in a single review and disposition step. In this way, CSR 627 efficiency and accuracy is greatly improved through the process of Mass Review in various embodiments. This essentially groups a series of similar online marketplace host Sellers/Users, for example, into one Mass Review case enabling a CSR 627 to quickly take action on all the online marketplace host Sellers/Users in that Mass Review case. Again, the various embodiments build all the proof and gather all the necessary information using the data gatherer 605 prior to presenting all the relevant aggregated data to the CSR 627 in such a way that the only thing that the CSR 627 has to do is make a decision without spending time on proof building or investigation.

As described above, various embodiments can automatically process referrals by selecting one or more policies and one or more consequence packages for disposing of a particular referral. Given the information from the input referral and the disposition produced for the related referral, data can be generated to identify correlations between the input referral and the resulting disposition. For example, a specific referral source (as identified in the referral) may be particularly accurate in submitting referrals the lead to a particular disposition result. Over time and with the collection of a set of historical data, a correlation can be drawn between the specific referral source and the resulting disposition. In the processing of subsequent referrals from the specific referral source for which correlation data has been collected, the processing of the referral can be streamlined or dispatched more quickly using the correlation data rather than processing the referral normally in a less timely fashion. Over time, the correlation data can be used to identify specific referral sources that represent the “top reporters” and for whom referrals can be processed more quickly. In another example, a specific referred party can be identified as a “frequent offender”, if the correlation data can be used to identify the specific referred party as being the object of several referrals that lead to a particular disposition. In another example, the result of appeals that may be handled in response to the disposition of a referral may also be factored into the correlation data. The referral, the disposition of the referral, and any appeal related to the referral may all be correlated to improve the speed and accuracy of the automated referral processing system of various embodiments. In general, the referral correlation data can be used to make the automatic referral processing operation more efficient over time as a greater wealth of historical, referral disposition, and referral appeal information is collected.

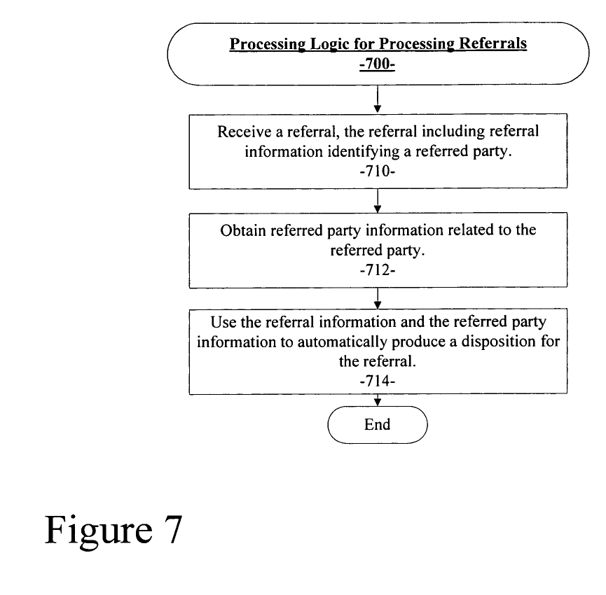

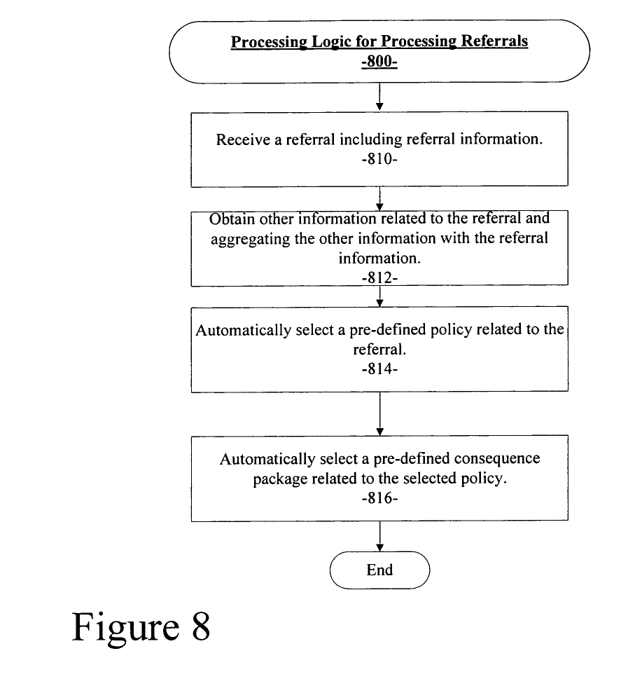

Referring now to FIGS. 7-8, flow diagrams illustrate the processing logic used in example embodiments. As shown in FIG. 7, a referral is received in processing block 710. In one example, the referral includes referral information identifying a referred party. At processing block 712, referred party information related to the referred party is obtained from various sources. Using the referral information and the referred party information, a disposition for the referral is automatically produced in processing block 714.

As shown in FIG. 8, a referral is received in processing block 810. In one example, the referral includes referral information. At processing block 812, other information related to the referral is obtained and aggregated with the referral information. Using the aggregated information, a pre-defined policy related to the referral is automatically selected in processing block 814. A pre-defined consequence package related to the selected policy is automatically selected in processing block 816.

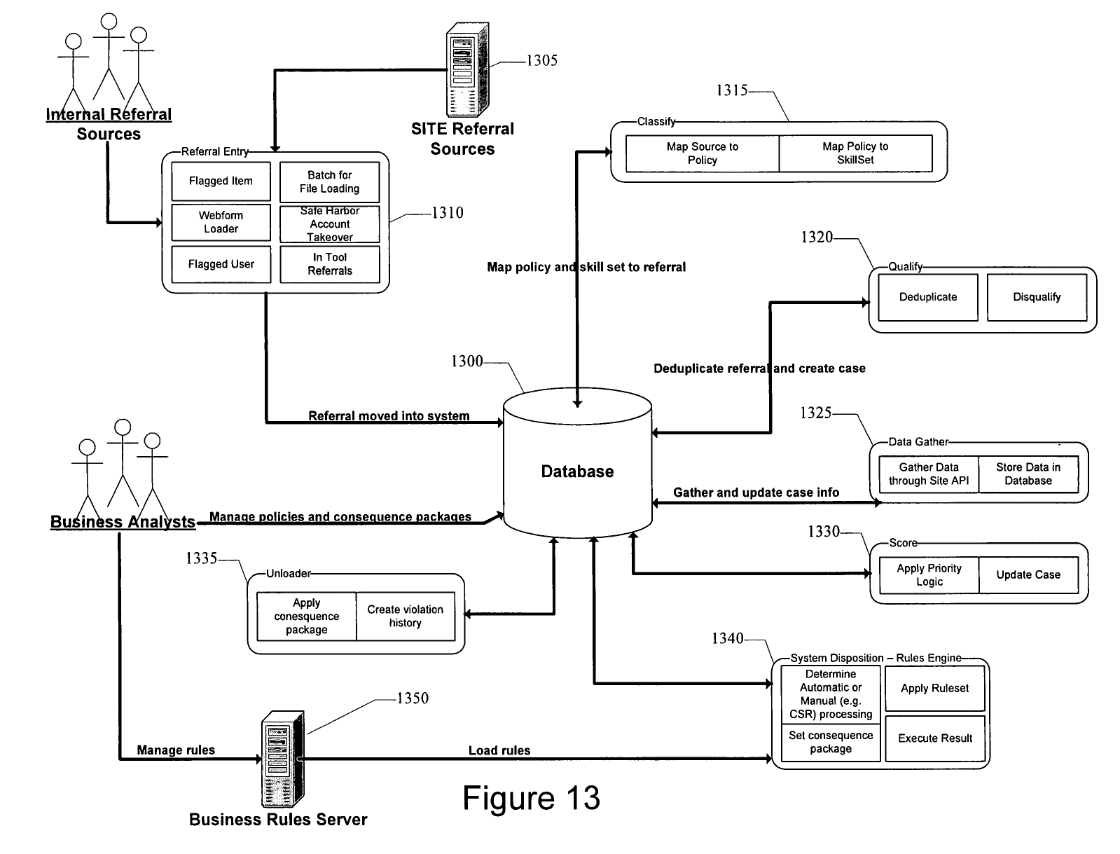

FIG. 13 illustrates an example of another embodiment. As shown, referrals can be generated from internal sources or from host site 1305 sources, typically received from other users. For example, internal referrals can be based on a particular flagged item or flagged user. Site 1305 referral sources can be obtained via a webform provided by a webform loader. As the referrals are received, the referral data is moved into a database 1300, wherein the referral data is accessible to other system components. In one process, the received referral is classified in a classifier component 1315. The classifier component 1315 can map the referral source to a corresponding policy as described above. Further, the classifier component 1315 can map a policy to a skillset associated with particular CSR's. If a particular referral needs to be referred to a CSR as described above, the referral can be referred to an appropriate CSR having the corresponding skillset. Received referrals can be further qualified or filtered using a qualifier component 1320, which can remove duplicate or non-compliant referrals. The received referral can also be processed by a data gatherer component 1325. The data gatherer component 1325 uses information provided in the referral to obtain other related information from other sources. One such source can be the site 1305, which can be accessed via an application programming interface (API). The other related information can include historical, behavioral, transactional, demographic, or other types of information related to the referral source and/or the referred party as identified in the referral. The other related information obtained by data gatherer component 605 can also be stored in database 1300. A scoring component 1330 can be used to apply a prioritization to the received referral. In this manner, the most important referrals (e.g. referrals that may have the most widespread system impact) can be identified and processed first. An unloader component 1335 applies a consequence package to the referral as associated with the matched policy and described above. The unloader component 1335 can also keep a history of the violations and consequences applied. A disposition component 1340 determines if the referral can be processed automatically or if a manual process (e.g. referral to a CSR) is required. The disposition component 1340 then processes the consequence package and disposes of the referral by taking the actions defined therein. In a separate flow, business analysts can define the business rules that are used to implement the referral policies and consequence packages. The referral policies and consequence packages can be so created and managed in database 1300. The referral policies and consequence packages can then be loaded by the disposition component 1340.

Thus, computer-implemented system and method for automatic disposition of referrals in an online marketplace are disclosed. While the present invention has been described in terms of several example embodiments, those of ordinary skill in the art will recognize that the present invention is not limited to the embodiments described, but can be practiced with modification and alteration within the spirit and scope of the appended claims. The description herein is thus to be regarded as illustrative instead of limiting.

What is claimed is:

1. A method comprising:
receiving a referral, the referral including referral information identifying a referred party;
obtaining referred party information related to the referred party; and
using the referral information and the referred party information to automatically produce a disposition for the referral.

2. The method as claimed in claim 1 wherein the referral information further includes information identifying a referral source.

3. The method as claimed in claim 1 further including obtaining other information related to the referral.

4. The method as claimed in claim 1 further including selecting a policy that most closely matches the referral.

5. The method as claimed in claim 1 further including assigning a consequence package to the referral.

6. The method as claimed in claim 5 further including automatically performing actions defined by the assigned consequence package leading to disposition of the referral.

7. A method comprising:
receiving a referral including referral information;
obtaining other information related to the referral and aggregating the other information with the referral information;
automatically selecting a pre-defined policy related to the referral; and
automatically selecting a pre-defined consequence package related to the selected policy.

8. The method as claimed in claim 1 wherein the referral information further includes information identifying a referral source.

9. The method as claimed in claim 1 further including assigning a skillset to the referral.

10. The method as claimed in claim 1 further including assigning a priority to the referral.

11. An article of manufacture comprising at least one machine readable storage medium having one or more computer programs stored thereon and operable on one or more computing systems to:
receive a referral, the referral including referral information identifying a referred party;
obtain referred party information related to the referred party; and
use the referral information and the referred party information to automatically produce a disposition for the referral.

12. The article of manufacture as claimed in claim 11 wherein the referral information further includes information identifying a referral source.

13. The article of manufacture as claimed in claim 11 further operable to obtain other information related to the referral.

14. The article of manufacture as claimed in claim 11 further operable to select a policy that most closely matches the referral.

15. The article of manufacture as claimed in claim 11 further operable to assign a consequence package to the referral.

16. The article of manufacture as claimed in claim 11 further operable to automatically perform actions defined by the assigned consequence package leading to disposition of the referral.

17. An article of manufacture comprising at least one machine readable storage medium having one or more computer programs stored thereon and operable on one or more computing systems to:
receive a referral including referral information;
obtain other information related to the referral and aggregating the other information with the referral information;
automatically select a pre-defined policy related to the referral; and
automatically select a pre-defined consequence package related to the selected policy.

18. The article of manufacture as claimed in claim 17 wherein the referral information further includes information identifying a referral source.

19. The article of manufacture as claimed in claim 17 further operable to assign a skillset to the referral.

20. The article of manufacture as claimed in claim 17 further operable to assign a priority to the referral.

21. A system comprising:
a data gatherer to receive a referral and to gather information related to the referral;
a policy engine to automatically select a pre-defined policy related to the referral; and
a consequence package engine to automatically select a pre-defined consequence package related to the selected policy

22. The system as claimed in claim 21 wherein the referral information further includes information identifying a referral source.

23. The system as claimed in claim 21 further operable to obtain other information related to the referral.

24. The system as claimed in claim 21 further operable to select a policy that most closely matches the referral.

25. The system as claimed in claim 21 further operable to assign a consequence package to the referral.

26. The system as claimed in claim 21 further operable to automatically perform actions defined by the assigned consequence package leading to disposition of the referral.
